(19) United States
(12) Patent Application Publication
(10) Pub. No.: US 2022/0292368 A1
(43) Pub. Date: Sep. 15, 2022

(54) CLASSIFICATION DEVICE, LEARNING DEVICE, CLASSIFICATION METHOD, LEARNING METHOD, CLASSIFICATION PROGRAM AND LEARNING PROGRAM

(71) Applicant: NIPPON TELEGRAPH AND TELEPHONE CORPORATION, Tokyo (JP)

(72) Inventors: Yoshiaki TAKIMOTO, Tokyo (JP); Hiroyuki TODA, Tokyo (JP); Tatsushi MATSUBAYASHI, Tokyo (JP); Shuhei YAMAMOTO, Tokyo (JP)

(73) Assignee: NIPPON TELEGRAPH AND TELEPHONE CORPORATION, Tokyo (JP)

(21) Appl. No.: 17/638,774

(22) PCT Filed: Aug. 29, 2019
(86) PCT No.: PCT/JP2019/034009

§ 371 Date: Feb. 25, 2022

(51) Int. Cl. G06N 5/02

(52) U.S. Cl. CPC G06N 5/022

(57) ABSTRACT

A classification unit of a classification device inputs input data to a learned model for classifying data into a class, to classify a class of the input data. The learned model includes a feature value extraction model for extracting a feature value from data and a classification model for classifying a class of data based on the feature value extracted by the feature value extraction model. In the learned model, respective parameters of the feature value extraction model and the classification model are trained in advance based on a supervised data set in a first domain in such a manner that a class classification result output from the learned model and a ground truth label correspond to each other. Also, the learned model is a learned model in which the parameter of the feature value extraction model is trained in advance via adversarial learning based on the supervised data set and an unsupervised data set in a second domain in such a manner that no classification of data input for training as to whether the data is either data in the first domain or data in the second domain is performed.

### TECHNICAL FIELD

A technique disclosed herein relates to a classification device, a learning device, a classification method, a learning method, a classification program and a learning program.

### BACKGROUND ART

Conventionally, techniques relating to domain adaptation have been known. For example, Non-Patent Literature 1 discloses a technique in which a learning model is trained based on ground truth labeled data in a training domain and ground truth unlabeled data in a test domain.

Also, Non-Patent Literature 2 discloses a technique in which domain adaptation is performed using adversarial learning.

### CITATION LIST

### Non-Patent Literature

Non-Patent Literature 1: Yaroslav Ganin, Evgeniya Ustinova, Hana Ajakan, Pascal Germain, Hugo Larochelle, Francios Laviolette, Mario Marchand, Victor Lempitsky, “Domain-Adversarial Training of Neural Networks”, Journal of Machine Learning Research 2016, vol 17, 3, https://arxiv.org/pdf/1505.07818.pdf
Non-Patent Literature 2: Michele Tonutti, Emanuele Ruffaldi, Alessandro Cattaneo, Carlo Alberto Avizzano, “Robust and Subject-independent Driving Manoeuvre Anticipation through Domain-Adversarial Recurrent Neural Networks”, https://arxiv.org/pdf/1902.0920.pdf

### SUMMARY OF THE INVENTION

### Technical Problem

For example, a neural network, which is an example of a learning model, includes a plurality of layers. In this case, parts having various functions such as a part that extracts a feature value and a part that performs classification are included in the learning model.

However, the techniques disclosed in Non-Patent Literatures 1 and 2 above, training for performing domain adaptation is performed for the entirety of the learning model and the respective functions included in the learning model are not taken into consideration.

Therefore, conventionally, there has been the problem of being unable to accurately classify data in a domain in which no ground truth-labeled supervised data is provided.

The disclosed technique has been created in view of the aforementioned point, and an object: of the disclosed technique is to accurately classify data in a domain in which no ground truth-labeled supervised data is provided.

### Means for Solving the Problem

A first aspect of the present disclosure provides a classification device including: an acquisition unit that acquires input data; and a classification unit that inputs the input data acquired by the acquisition unit to a learned model for classifying data into a class, to classify a class of the input data, wherein the learned model is a learned model including a feature value extraction model for extracting a feature value from data, and a classification model for classifying a class of data based on the feature value extracted by the feature value extraction model, based on a supervised data set that is a data set in which data belonging to a first domain is provided with a ground truth label representing a class of the data, respective parameters of the feature value extraction model and the classification model being trained in advance in such a manner that a class classification result output from the learned model, and the around truth label correspond to each other, based on the supervised data set and an unsupervised data set that is a data set in which data belonging to a second domain is provided with no ground truth label representing a class of the data, the parameter of the feature value extraction model being trained in advance via adversarial learning in such a manner that no classification of data input for training as to whether the data is either data in the first domain or data in the second domain is performed.

A second aspect of the present disclosure provides a learning device including a learning unit that obtains a learned model for classifying data into a class, by, based on a supervised data set that is a data set in which data belonging to a first domain is provided with a ground truth label representing a class of the data, training a parameter of a feature value extraction model for extracting a feature value from data and a parameter of a classification model for classifying a class of data based on the feature value extracted by the feature value extraction model, in a learning model for classifying data into a class, in such a manner that a class classification result output from the learning model and the ground truth label correspond to each other, and based on the supervised data set and an unsupervised data set that is a data set in which data belonging to a second domain is provided with no ground truth label representing a class of the data, training the parameter of the feature value extraction model in the learning model via adversarial learning in such a manner that no classification of data input for training as to whether the data is either data in the first domain or data in the second domain is performed.

### Effects of the Invention

The disclosed technique enables accurately classifying data in a domain in which no around truth-labeled supervised data is provided.

### BRIEF DESCRIPTION OF DRAWINGS

FIG. 1 is a block diagram illustrating a hardware configuration of a learning device 10 of the present embodiment.

FIG. 2 is a block diagram illustrating a hardware configuration of a classification device 20 of the present embodiment.

FIG. 3 is a block diagram illustrating example functional configurations of the learning device 10 and the classification device 20 of the present embodiment.

FIG. 4 is a diagram illustrating an example of a learning model of a first embodiment.

FIG. 5 is a flowchart illustrating a flow of learning processing by the learning device 10.

FIG. 6 is a flowchart illustrating a flow of classification processing by the classification device 20.

FIG. 7 is a diagram illustrating an example of a learning model of a second embodiment.

FIG. 8 is a diagram indicating a result of Example 1.

FIG. 9 is a diagram indicating a result of Example 1.

FIG. 10 is a diagram indicating a result of Example 1.

FIG. 11 is a diagram indicating a result of Example 1.

FIG. 12 is a diagram illustrating a learning mode used in Example 2.

FIG. 13 is a diagram indicating results of Example 2.

FIG. 14 is a diagram indicating results of Example.

### DESCRIPTION OF EMBODIMENTS

Embodiments of the disclosed technique will be described below with reference to the drawings. In the drawings, components or parts that are identical or equivalent to each other are provided with a same reference sign. Also, dimensional ratios in the drawings are exaggerated for ease of description and may be different from actual ones.

### First Embodiment

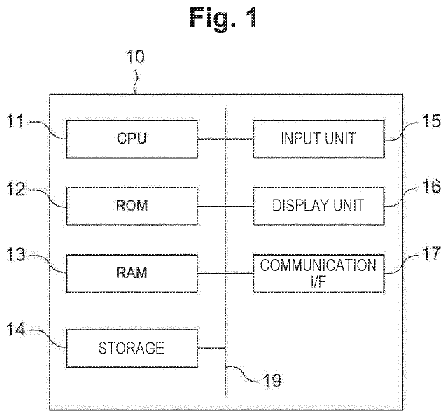

FIG. 1 is a block diagram illustrating a hardware configuration of a learning device 10 of a first embodiment.

As illustrated in FIG. 1, the learning device 10 of the first embodiment includes a CPU (central processing unit) 11, a ROM (read-only memory) 12, a RAM (random access memory) 13, a storage 14, an input unit 15, a display unit 16 and a communication interface (I/F) 17. The respective components are connected via a bus 19 in a mutually communicable manner.

The CPU 11 is a central arithmetic processing unit and executes various programs and controls the respective components. In other words, the CPU 11 reads a program from the ROM 12 or the storage 14 and executes the program using the RAM 13 as a work area. The CPU 11 performs control of the respective components and various kinds of arithmetic processing according to programs stored in the ROM 12 or the storage 14. In the present embodiment, in the ROM 12 or the storage 14, various programs for processing information input via an input device are stored.

The ROM 12 stores various programs and various data. The RAM 13 temporarily stores a program or data as a work area. The storage 14 includes, e.g., an HDD (hard disk drive) or an SSD (solid-state drive) and stores various programs including an operating system, and various data.

The input unit 15 includes a pointing device such as a mouse, and a keyboard and is used for providing various inputs.

The display unit 16 is, for example, a liquid-crystal display and displays various information pieces.

The display unit 16 may function as the input unit 15 via employment of a touch panel system.

The communication I/F 17 is an interface for communication with other devices such as the input device, and employs a standard, for example, Ethernet (registered trademark), FDDI or Wi-Fi (registered trademark).

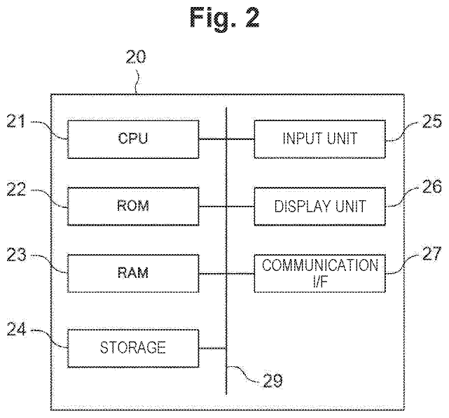

FIG. 2 is a block diagram illustrating a hardware configuration of a classification device 20 of the first embodiment.

As illustrated in FIG. 2, the classification device 20 of the first embodiment includes a CPU 21, a ROM 22, a RAM 23, a storage 24, an input unit 25, a display unit 26 and a communication I/F 27. The respective components are connected via a bus 29 in a mutually communicable manner.

The CPU 21 is a central arithmetic processing unit and executes various programs and controls the respective components. In other words, the CPU 21 reads a program from the ROM 22 or the storage 24 and executes the program using the RAM 23 as a work area. The CPU 21 performs control of the respective components and various kinds of arithmetic processing according to programs stored in the ROM 22 or the storage 24. In the present embodiment, in the ROM 22 or the storage 24, various programs for processing information input via an input device are stored.

The ROM 22 stores various programs and various data. The RAM 23 temporarily stores a program or data as a work area. The storage 24 includes, e.g., an HDD or an SSD and stores various programs including an operating system, and various data.

The input unit 25 includes a pointing device such as a mouse, and a keyboard and is used for providing various inputs.

The display unit 26 is, for example, a liquid-crystal display and displays various information pieces.

The display unit 26 may function as the input unit 25 via employment of a touch panel system.

The communication I/F 27 is an interface for communication with other devices such as the input device, and employs a standard, for example, Ethernet (registered trademark), FDDI or Wi-Fi (registered trademark).

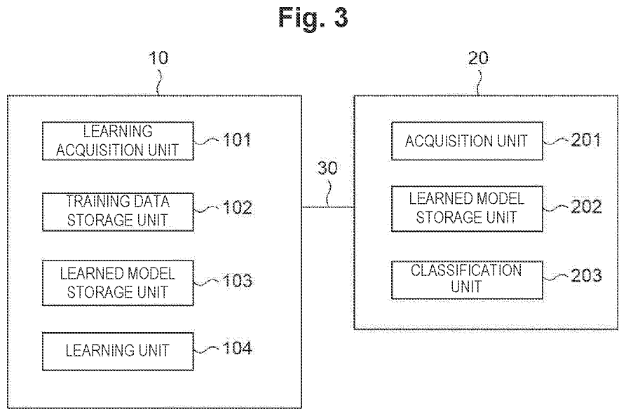

Next, functional configurations of the learning device 10 and the classification device 20 of the first embodiment will be described. FIG. 3 is a block diagram illustrating example functional configurations of the learning device 10 and the classification device 20. The learning device 10 and the classification device 20 are connected by predetermined communication means 30.

[Learning Device 10]

As illustrated in FIG. 3, the learning device 10 includes a learning acquisition unit 101, a training data storage unit 102, a learned model storage unit 103 and a learning unit 104 as functional components. Each of the functional components is implemented by the CPU 11 reading a learning program stored in the ROM 12 or the storage 14, loading the program to the RAM 13 and executing the program.

The learning acquisition unit 101 acquires training data sets. The training data sets of the present embodiment include a supervised data set and an unsupervised data set. The supervised data set of the present embodiment is a data set in which each of data belonging to a source domain, which is an example of a first domain, is provided with a ground truth label representing a class. Also, the unsupervised data set of the present embodiment is a data set in which each of data belonging to a target domain, which is an example of a second domain is provided with no ground truth label representing a class.

Upon reception of the training data sets, the learning acquisition unit 101 stores the training data sets into the training data storage unit 102.

In the training data storage unit 102, the training data sets are stored. Each of the data included in the supervised data set is provided with a class the data belongs to as a ground truth label in advance. On the other hand, each of the data included in the unsupervised data set is provided with no ground truth label.

In the present embodiment, a case where a combination of a forward image at each of times, the forward image being picked up by a camera mounted in a vehicle, and sensor information pieces detected by respective sensors installed in the vehicle and information representing an object present ahead of the vehicle is used as data will be described as an example. The data in the present embodiment are data collected in advance by a dashboard camera installed in the vehicle.

Note that data xᵢ in the present embodiment is data that is a combination of a forward image x^{image}, sensor information x^{sensor} and an object detection result x^{object} for the forward image. Also, a label Y={1, . . . , L} and each data is classified into any of the L labels. Also, a domain D presents a distribution on a X×Y space. Also, a hypothesis h represents a function X→Y, and h(x) indicates a label output when x is input to a learning model.

In this case, each of the data included in the supervised data set is provided with a combination of occurrence or non-occurrence of a near miss representing a degree of danger and a category of a target of the near miss (for example, a vehicle or a pedestrian) as a ground truth label. On the other hand, each of the data included in the unsupervised data set is provided with no such ground truth label.

In the present embodiment, a later-described learning model is trained using a supervised data set including data belonging to a source domain and an unsupervised data set including data belonging to a target domain.

There may be a case where a dangerous situation such as a traffic accident or a near miss is extracted from data collected from dashboard cameras using an existing learning model such as a neural network. In this case, it is necessary to provide a large amount of teaching data for training the learning model via human labor. Furthermore, such teaching data need to belong to a same domain. Here, “domain” represents a collection of data collected under a specific condition.

For example, it is conceivable that labelling of occurrence or non-occurrence of a near miss and a cause of the near miss is performed by human labor through viewing a huge amount of video data. This work requires attention and much time and thus is high-cost work. Also, it is possible that a near miss is extracted by a learned model trained using an existing supervised data set; however, the data are different in domain the data belong to. Therefore, the nature of the entire collected data differs because of various factors such as the type of the vehicle, the region where the data were collected and differences in type of the camera and place where the camera is installed, and thus, accuracy of the data is limited.

Therefore, in the present embodiment, a learned model is obtained by training a learning model using both an existing supervised data set of supervised data collected in a source domain D_{S}, which is a certain domain, and an unsupervised data set of unsupervised data collected in a target domain D_{T}, which a domain that is different from the certain domain. In the present embodiment, a learning model having learned parameters obtained via machine learning is referred to as “learned model”. Then, in the present embodiment, extraction and classification of near misses from data collected in the target domain D_{T} are performed using a learned model.

More specifically, in the present embodiment, a learning model is trained with a domain-adversarial neural network (DANN) model, which is a domain adaptation technique using adversarial learning in Non-Patent Literature 1 mentioned above, incorporated in an existing convolutional recurrent neural networks (CRNN)-based model. Here, for the CRNN-based model, see, for example, the reference literature (Shuhei Yamamoto, Takeshi Kurashima, Hiroyuki Toda, “Traffic Near-miss Target Classification on Event Recorder Data”, DICOMO, 2018).

In this case, it is conceivable that a feature value obtained from a convolutional neural networks (hereinafter simply referred to as “CNN”) part, which is an example of a model for extracting a feature value, exhibits a large difference between a plurality of domains due to the factors previously mentioned. On the other hand, it is conceivable that an RNN part provides a feature value common to the domains because, e.g., a process of occurrence of a near miss has been learned. Therefore, efficient extraction of a feature common to domains can be expected by performing adversarial learning only for the CNN part.

Therefore, in the present embodiment, domain adaptation using adversarial learning is performed using an existing CRNN-based model as a base, with an addition of a layer for estimation of an environment of collection. Consequently, extraction of an environment-independent feature value can be expected for the CNN part that conventionally extracts a feature value largely depending on the environment of collection.

Note that in the present embodiment, a supervised data set S in the source domain D_{S} and an unsupervised data set T in the target domain D_{T} are defined as follows.

S={xᵢ,yᵢ}ᵢ₌₁^{I}˜(D_{S})^{I}

T={xⱼ}ⱼ₌₁^{J}˜(D_{T})^{J} [Math. 1]

Note that i and j each represent an index of data, I and J each represent a total number of the data. Also, x represents the data and y represents a ground truth label. Also, there may be a plurality of unsupervised data sets S or unsupervised data sets T like, S₁, S₂, . . . or T₁, T₂, . . . . Also, some data in the unsupervised data set T may be provided with a ground truth label y.

In the learned model storage unit 103, a learning model for classifying data into a class is stored. Parameters included in the learning model are trained by the later-described learning unit 104.

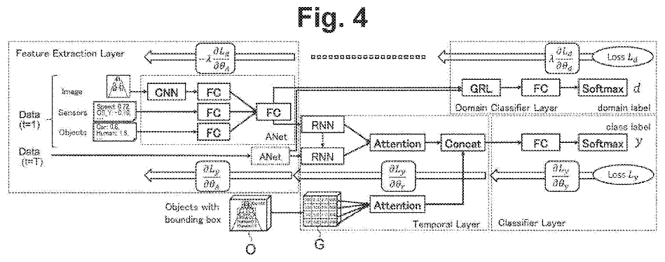

FIG. 4 illustrates an example of a learning model (or a learned model) of the present embodiment. As illustrated in FIG. 4, the learning model of the present embodiment includes the following four layers. A first layer is a feature extraction layer (hereinafter simply referred to as “FEL”) that is a feature value extraction model for extracting a feature value from data. A second layer is a temporal layer (hereinafter simply referred to as “TL”), which is an example of a chronological model for extracting chronological change of the data. A third layer is a classifier layer (hereinafter simply referred to as “CL”) that is an example of a classification model for classifying a class of the data. A fourth layer is a domain classifier layer (hereinafter simply referred to as “DCL”) that is an example of a domain classification model for classifying a domain class.

Also, as illustrated in FIG. 4, the FEL of the learning model includes an ANet including a CNN and a full connect layer (hereinafter simply referred to as “FC”), which are known existing neural network techniques.

Also, as illustrated in FIG. 4, the TL of the learning model includes an RNN, an attension layer and a contact layer, which are known existing neural network techniques.

Also, as illustrated in FIG. 4, the CL of the learning model includes a softmax and an FC, which are known existing neural network techniques.

Also, as illustrated in FIG. 4, the DCL of the learning model includes a gradient reversal layer (hereinafter simply referred to as “GRL”), an FC and a softmax, which are known existing neural network techniques.

Here, the GRL is a layer that multiplies a gradient for backpropagation in learning processing by −1, the layer being provided for performing adversarial learning. Accordingly, on a layer on the input side relative to a GRL, training is performed in such a manner that a feature value with which domain classification cannot be performed is extracted, and on a layer on the output side relative to a GRL, training is performed in such a manner that domain classification can be performed.

Also, the learning model is provided with objects with bounding box 0, which is a known neural network technique, and data is input to grid embedding G, which is a known neural network technique.

The learning unit 104 trains the learning model based on the supervised data set stored in the training data storage unit 102 in such a manner that a class classification result output from the learning model and a ground truth label correspond to each other. More specifically, for each of the supervised data included in the supervised data set, the learning unit 104 trains the learning model in such a manner that a class classification result output from the learning model when training data xᵢ is input to the learning model and a ground truth label yᵢ correspond to each other. Note that the learning unit 104 trains the learning model using each of the training data xᵢ of i=1 to I.

Also, the learning unit 104 trains the learning model using adversarial learning based on the supervised data set and the unsupervised data set stored in the training data storage unit 102, in such a manner that no classification of data input for training is as to whether the data is either data in the source domain or data in the target domain is performed. More specifically, the learning unit 104 trains the learning model using adversarial learning based on the supervised data set and the unsupervised data set in such a manner that no classification of data input for training as to whether the data is either data in data in the source domain D_{S} or data in the target domain D_{T} is performed.

Consequently, a learned model meeting the below expression is generated.

$$min {Pr}_{\{ x , y \} ∼ {D}_{T}} \{ h ( x ) \neq y \} \qquad [ Math . 2 ]$$

The above expression represents that the probability of an output h(x) when data x in the domain D_{T} is input being different from the ground truth label y is minimized.

Here, Ly is a loss function representing a difference between a class classification result of supervised data output from the CL of the learning model when the supervised data is input to the learning model and a ground truth label of the supervised data. Also, Ld is a loss function representing a difference between a class classification result of a domain output from the DCL of the learning model when both supervised data and unsupervised data are input to the learning model and a label of a ground truth domain.

In the present embodiment, the learning model is trained in such a manner that a value of a loss function Loss in Expression (1) below, which includes the loss function LossLy and the loss function LossLd, is minimized. Note that for a learning algorithm for training the learning model, e.g., Adam, which is a known technique, can be used.

Loss=LossLy+λ·LossLd (1)

Note that λ in Expression (1) above is a hyperparameter for adjusting a scale between the two loss functions. Also, where functions f learned by sub-elements of the learning model and parameters θ of the functions are (f_{A}, θ_{A}), (fᵣ, θᵣ), (f_{y}, θ_{y}), (f_{d}, θ_{d}) in the order of the FEL, the TL, the CL, the DCL, flows of forward propagation and backpropagation during training are such as illustrated in FIG. 4.

Learning processing is performed based on derivative functions of parameters with respect to the respective loss functions, which are indicated in the below expressions.

$$\frac{\partial {L}_{d}}{\partial {θ}_{d}} \\ \frac{\partial {L}_{d}}{\partial {θ}_{A}} \\ \frac{\partial {L}_{y}}{\partial {θ}_{A}} \\ \frac{\partial {L}_{y}}{\partial {θ}_{r}} \\ \frac{\partial {L}_{y}}{\partial {θ}_{y}} \qquad [ Math . 3 ]$$

The learning unit 104 stores the learned model trained in such a manner that the value of the loss function Loss in Expression (1) above is minimized, in the learned model storage unit 103. Consequently, a learned model for accurately classifying data belonging to the target domain is obtained.

Also, the learning model is trained using all of the data in both the unsupervised data set T and the supervised data set S, and the training is performed in such a manner that a class classification problem of the supervised data set S can be solved and domain classification cannot be performed. Therefore, a learned model that performs class classification using a domain-independent feature value can be obtained.

[Classification Device 20]

As illustrated in FIG. 3, the classification device 20 includes an acquisition unit 201, a learned model storage unit 202 and a classification unit 203 as functional components. Each of the functional components is implemented by the CPU 21 reading a learning program stored in the ROM 22 or the storage 24, loading the learning program onto the RAM 23 and executing the learning program.

The acquisition unit 201 acquires input data that is data subject to class classification.

In the learned model storage unit 202, a learned model trained by the learning device 10 is stored.

The classification unit 203 inputs the input data acquired by the acquisition unit 201 to the learned model stored in the learned model storage unit 202 and acquires a class classification result for the input data.

Since the learned model stored in the learned model storage unit 103 is trained in such a manner that the value of the loss function indicated in Expression (1) above is minimized, a class classification result for the input data is accurately created. Furthermore, the learned model can accurately classify data in the target domain in which only unsupervised data is provided.

Next, operation of the learning device 10 will be described.

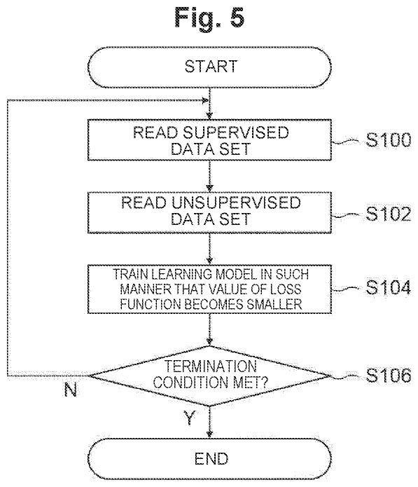

FIG. 5 is a flowchart illustrating a flow of learning processing by the learning device 10. Learning processing is performed by the CPU 11 reading the learning program stored in the ROM 12 or the storage 14, loading the learning program onto the RAM 13 and executing the learning program.

First, as the learning acquisition unit 101, the CPU 11 acquires, for example, training data sets input from the input unit 15 and stores the training data sets in the training data storage unit 102. Then, upon reception of an instruction signal for execution of learning processing, the CPU 11 executes the learning processing illustrated in FIG. 5.

In step S100, as the learning unit 104, the CPU 11 reads a supervised data set stored in the training data storage unit 102. The supervised data set includes data S={xᵢ, yᵢ}^{I}ᵢ₌₁ belonging to the source domain D_{S}, each of the data S being provided with a ground truth label.

In step S102, as the learning unit 104, the CPU 11 reads an unsupervised data set stored in the training data storage unit 102. The unsupervised data set includes data T={xⱼ}^{J}ⱼ₌₁ in the target domain D_{T}, each of the data T being provided with no ground truth label.

In step S104, as the learning unit 104, the CPU 11 inputs data of the supervised data set read in step S100 and the unsupervised data set read in step S102 to the learning model and trains the respective parameters of the learning model in such a manner that the value of the loss function Loss indicated in Expression (1) above is minimized.

In step S106, as the learning unit 104, the CPU 11 determines whether or not a repetition termination condition is met. If the repetition termination condition is met, the processing ends. On the other hand, if the repetition termination condition is not met, the processing returns to step S100. The processing in steps S100 to S106 is repeated until the termination condition is met.

Note that the termination condition is set in advance. As the repetition condition, for example, “the processing ends after being repeated a predetermined number of times (for example, 100 times)” or “the processing ends if a decrease in value of the loss function remains within a certain range during the processing being repeated a certain number of times” is set.

As a result of the above learning processing being executed, the parameters of the learning model are updated and a learned model for accurately classifying a class of data is stored in the learned model storage unit 103.

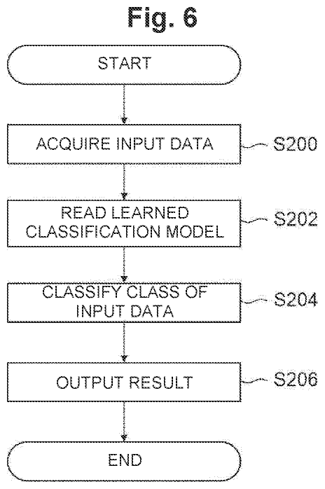

Next, operation of the classification device 20 will be described below. FIG. 6 is a flowchart illustrating a flow of classification processing by the classification device 20. Classification processing is performed by the CPU 21 reading a classification processing program stored in the ROM 22 or the storage 24, loading the classification processing program onto the RAM 23 and executing the classification processing program.

Upon the learned model being stored in the learned model storage unit 103 by the learning device 10, the learned model is stored in the learned model storage unit 202 of the classification device 20 via the communication means 30.

Upon reception of input data to be subjected to class classification from, e.g., the input unit 25, as the acquisition unit 201, the CPU 21 of the classification device 20 executes the classification processing illustrated in FIG. 6.

In step S200, as the acquisition unit 201, the CPU 21 acquires the input data.

In step S202, as the classification unit 203, the CPU 21 reads the learned model stored in the learned model storage unit 103.

In step S204, as the classification unit 203, the CPU 21 inputs the input data acquired in step S200 to the learned model read in step S202 to classify a class of the input data.

In step S206, as the classification unit 203, the CPU 21 outputs a classification result created in step S204 and ends the classification processing.

As described above, based on a supervised data set that is a data set in which data belonging to a source domain is provided with a ground truth label representing a class of the data, the learning device 10 of the present embodiment trains a learning model for classifying data into a class, in such a manner that a class classification result output from the learning model and the ground truth label correspond to each other. Also, based on the supervised data set and an unsupervised data set, the learning device 10 of the present embodiment trains the learning model via adversarial learning in such a manner that no classification of data input for training as to whether the data is either data in a source domain or data in a target domain. Consequently, the learning device 10 of the present embodiment obtains a learned model for classifying data into a class. Consequently, a learned model for accurately classifying data in a domain in which no ground truth-labeled supervised data is provided can be obtained. Here, the unsupervised data set is a data set in which each of data belonging to a target domain is provided with no ground truth label representing a class of the data.

Also, the classification device 20 of the present embodiment inputs input data into a learned model for classifying data into a class, to classify the input data into a class. The learned model is a learned model trained in advance based on a supervised data set that is a data set in which data belonging to a source domain is provided with a ground truth label representing a class of the data, in such a manner that a class classification result output from the learned model and the ground truth label correspond to each other. In addition, the learned model is a learned model trained in advance via adversarial learning based on the supervised data set and an unsupervised data set in such a manner that no classification of data input for training as to whether the data is data in the source domain or data in the target domain. Consequently, it is possible to accurately classify data in a domain in which no ground truth-labeled supervised data is provided. Here, the unsupervised data set is a data set in which data belonging to the target domain is provided with no ground truth label representing a class of the data.

Also, a part, on the input side relative to the RNN, of the learning model can be considered as a part that perceives a state of data at each time. Also, the RNN part of the learning model can be considered as a part that perceives temporal change of the data. Also, a part, on the output side relative to the RNN, of the learning model can be considered as a part that comprehensively perceives a near miss representing a degree of danger.

Therefore, in the present embodiment, subjecting the part, on the input side relative to the RNN, of the learning model to domain adaptation enables obtaining a learned model that accurately classifies data in a domain in which no ground truth-labeled supervised data is provided.

Note that when a learning model is trained using a new domain, conventional “fine-tuning” only needs a learned model with no need for data in an existing domain. However, in this case, a supervised data set in a new domain is needed.

On the other hand, in adversarial learning used in the present embodiment, both data in a new domain and data in an existing domain are learned at the same time. Note that there is no limitation on the number of domains.

The present embodiment enables training parameters of a feature value extraction model that extracts a feature value essentially necessary for classification, and has the possibility of enhancing generalization performance for classification for an existing domain. Furthermore, the need for a supervised data set in a new domain is eliminated, enabling accurately classifying data in a domain in which no ground truth-labeled supervised data is provided.

### Second Embodiment

Next, a second embodiment will be described. Note that a configuration of a system according to the second embodiment is similar to the configuration of the first embodiment, and thus, reference signs that are the same as those of the first embodiment are provided and description of the configuration is omitted.

The second embodiment is different from the first embodiment in configuration of a learning model.

Data used in the present embodiment includes a plurality of modals as a plurality of kinds of data. More specifically, data used in the present embodiment is data representing a combination of a forward image, sensor information and information representing an object.

In this case, it is conceivable that each of the modals of the data is biased and the biases affect class classification.

Therefore, in the second embodiment, a domain classification model for classification as to whether data is data in a source domain or data in a target domain is provided for each modal, and a parameter of a CNN, which is an example of a feature value extraction model, is trained.

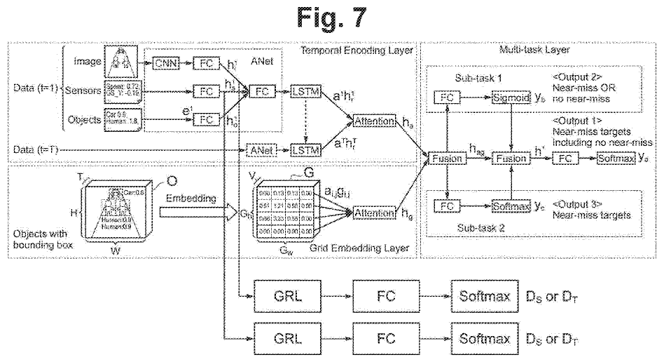

FIG. 7 is an example of a learning model to be trained in the second embodiment. As illustrated in FIG. 7, on the output side of a CNN in the learning model, domain classification models are provided for the respective modals.

Also, as illustrated in FIG. 7, the learning model of the second embodiment includes a temporal encoding layer, a grid embedding layer and a multi-task layer.

An Anet of the temporal encoding layer extracts a feature value, and an LSTM and an attension extracts chronological change of the data. Note that the “Image” illustrated in FIG. 7 represents a forward image of a vehicle, the “Sensor” represents sensor information and “Object” represents object detection information. Note that data at times t=1 to T are input to the temporal encoding layer.

Here, e₁ of the temporal encoding layer is a vector representing object detection information. Also, each of hᵢ¹, hₐ¹ and hₒ¹ is a vector output from an FC. Also, each of a¹hᵣ¹, . . . , a^{T}hᵣ^{T} is a vector output from the LSTM. Also, hₐ is a vector output from the attension of the temporal encoding layer.

The grid embedding layer inputs forward images at respective times, each of the forward images being provided with an object detection result. As illustrated in FIG. 7, the forward images have a size of W×H and forward images during T hours are input. A layer representing a neural network of the grid embedding layer has a size of Gw×Gh×V provided with respective weight coefficients. A vector a_{i,j}g_{i,j} is output from the neural network. Then, the attension of the grid embedding layer outputs a vector h_{q}.

The multi-task layer executes processing including class classification. A sub-task 1 outputs a score yb representing a degree of a near miss as output 2. As illustrated in FIG. 7, the sub-task 1 includes a sigmoid, which represents a sigmoid function, and an FC. Also, a sub-task 2 outputs a classification result y_{c} for an object causing a near miss as output 3. The sub-task 2 includes an FC and a softmax. Also, the multi-task layer outputs information ya including the classification result for an object causing a near miss and a classification result for an object causing no near miss as output 1. A vector h_{ag} is output from a first fusion, which is an existing neural network technique, and h′ is output from a second fusion. Then, the output from the FC is input to the softmax, and ya is output as output 1.

Also, as illustrated in FIG. 7, the domain classification model includes a GRL, an FC and a softmax. A classification result representing whether input data belongs to a source domain D_{S} or a target domain D_{T} is output from the softmax of the domain classification model.

As illustrated in FIG. 7, the domain classification model performs classification of data input for training as to whether the data is data in a source domain or data in a target domain, for each modal of data. Therefore, a learning unit 104 of the second embodiment trains a parameter of a feature value extraction model of the learning model, for each domain of data.

In this case, the learning unit 104 of the second embodiment trains the learning model in such a manner that a value of a function obtained by a weighted sum of the loss function Loss used in the first embodiment, a loss function Loss1 for a modal 1 and a loss function Loss2 for a modal 2 is minimized as indicated in the below expression. Here, λ1 and λ2 are weight coefficients for the loss function Loss1 for the modal 1 and the loss function Loss2 for the modal 2, respectively.

Loss+λ1·Loss1+λ2·Loss2

The rest of configuration and operation of the second embodiment is similar to that of the first embodiment, and thus, description thereof is omitted.

As described above, in the domain classification model of the learning device of the second embodiment, classification of each of data input for training as to whether the data is data in a source domain or data in a target domain is performed for each type of data, and a parameter of the feature value extraction model of the learning model is trained for each kind of data. Consequently, the domain classification model of the learning device according to the second embodiment can accurately classify data in a domain in which no ground truth-labeled supervised data is provided, in consideration of differences depending on the modals.

For example, a forward image largely differs depending on the position at which a camera is installed. On the other hand, sensor information obtained by sensors mounted in a vehicle does not differ so much between vehicles. Therefore, taking differences depending on the modals into consideration enables the domain classification model of the learning device according to the second embodiment to accurately classify data in a domain in which no ground truth-labeled supervised data is provided.

Also, in particular, where there are a plurality of domains, the present embodiment is particularly effective.

For example, where a learning model is trained using training data belonging to domains 1 to 3, data in domain 1 and data in domain 2 may be similar in the forward images but may be different in the sensor information.

Also, the data in domain 1 and the data in domain 3 may be similar in sensor information but may be different in the forward images. Also, the data in domain 2 and the data in domain 3 may be different in both the forward images and the sensor information.

Therefore, a learned model that can accurately classify data in a domain in which no ground truth-labeled supervised data is provided can be obtained by subjecting a learning model to domain adaptation not using all of data equally but using a necessary part of the data.

### EXAMPLES

Next, examples will be described.

### Example 1

In Example 1, a test was conducted using the learning model of the first embodiment.

[1.1 Test Conditions]

As data sets used in the test, data A in a certain domain and data B in a domain that is different from that of data A was used.

Data A were data collected via dashboard cameras installed in taxies in Japan. Data A were data collected in such a manner that the positions at which the dashboard cameras are installed and the types of the vehicles were specified. On the other hand, data B were data collected via dashboard cameras installed in corporate vehicles in Japan, and the positions at which the dashboard cameras are installed and the types of the vehicles vary widely.

Each event data includes, with a time at which an acceleration trigger reacted (for example, when an absolute value of an acceleration became equal to or exceeded a predetermined threshold value) as a center, a series of forward images in a time range of ten-odd seconds before and after the time and sensor information pieces in the time range of ten-odd seconds before and after the time. These data were recorded at a rate of 30 [fps]. Note that sensor information acquired by sensors mounted in a vehicle includes three kinds of data, a longitudinal acceleration of the vehicle, a lateral acceleration of the vehicle and a speed of the vehicle. Also, for object detection, YOLOv2 (see, for example, the reference literature (Joseph Redmon and Ali Farhadi., “YOLO9000: Better, Faster, Stronger”, In CVPR, pages 7263-7271, 2017)), which is a known technique, was used.

Also, each event data is provided with a label of occurrence or non-occurrence of an accident or a near miss and a target of the near miss (e.g., a vehicle or a bicycle) by a person who has carefully inspected the event data. In Example 1, a learned model was evaluated via 3-class classification tasks {safe, near miss, accident} and 4-class classification tasks {safe, vehicle, bicycle, pedestrian}. The number of training data sets and the number of test data sets for each label were as indicated in Table 1 below. In the table, “Train” represents training data sets and “Test” represents test data sets.

TABLE 1

| | |
|---|---|
| Data A | Data B |

| | Label | Train | Test | Train | Test |
|---|---|---|---|---|---|
| 3-class | Safe | 5600 | 350 | 2765 | 350 |
| | Near miss | 2000 | 125 | 987 | 125 |
| | Accident | 400 | 25 | 198 | 25 |
| 4-class | Safe | 3584 | 224 | 1792 | 224 |
| | Vehicle | 512 | 32 | 256 | 32 |
| | Bicycle | 512 | 32 | 256 | 32 |
| | Pedestrian | 512 | 32 | 256 | 32 |

For implementation, Chainer (see the Internet <URL: https://chainer.org>) was used. In the learning model, the number of FC units was 256 and the CNN had three layers. For the RNN, an LSTM (see, for example, the reference literature (Hasim Sak, Andrew Senior, and Francoise Beaufays, “Long Short-Term Memory Recurrent Neural Network Architectures for Large Scale Acoustic Modeling”, In ISCA, 2014)) was used. For a learning algorithm used for optimization, Adam (Diederik P. Kingma and Jimmy Ba., “Adam: A Method for Stochastic Optimization”, In ICLR, 2015) was used.

[1.2 Comparison Method]

In Example 1, the below four types of techniques (learned models) were evaluated.

“SourceModel” represents a learned model obtained by performing supervised learning using data in a source domain alone. Also, “Supervised” represents a learned model obtained by performing supervised learning using data in a target domain alone. Also, “DARNN” represents a learned model obtained by training a model employing a DANN adaptation method proposed in the reference literature (Michele Tonutti, Emanuele Ruffaldi, Alessandro Cattaneo, and Carlo Alberto Avizzano, “Robust and Subject-Independent Driving Manoeuvre Anticipation Through Domain-Adversarial Recurrent Neural Networks”, ROBOT AUT S, 115:162-173, 2019). Note that “DARNN” is a learned model where the input of the GRL in FIG. 1 is not the ANet but a Concat layer of the CL layer and domain adaptation was performed also for the RNN part. Also, “Proposed” represents a learned model trained by the proposed method described in the first embodiment. For training of “DARNN” and “Proposed”, data and labels in the source domain, and data alone in the target domain were used.

[1.3 Test Result]

Accuracies of the respective models for the respective tacks are indicated in Tables 2 and 3 below.

TABLE 2

| | |
|---|---|
| Data A ⇒ Data B | Data B ⇒ Data A |

| | 3-class | 4-class | 3-class | 4-class |
|---|---|---|---|---|
| SourceModel | 0.362 | 0.351 | 0.406 | 0.444 |
| Supervised | 0.958 | 0.874 | 0.922 | 0.790 |
| DARNN | 0.954 | 0.891 | 0.918 | 0.814 |
| Proposed | 0.974 | 0.883 | 0.932 | 0.830 |

TABLE 3

| | |
|---|---|
| Data A ⇒ Data B | Data B ⇒ Data A |

| | 3-class | 4-class | 3-class | 4-class |
|---|---|---|---|---|
| SourceModel | 0.311 | 0.702 | 0.411 | 0.511 |
| Supervised | 0.954 | 0.891 | 0.911 | 0.822 |
| DARNN | 0.951 | 0.882 | 0.900 | 0.794 |
| Proposed | 0.972 | 0.888 | 0.930 | 0.840 |

Here, “data A→data B” indicated in the tables represents that the data in the source domain was data A and the data in the target domain was data B. Also, “data B→data A” represents that the data in the source domain was data B and the data in the target domain was data A.

From the results indicated in the above tables, it can be seen that domain adaptation using adversarial learning is effective in near miss detection and classification tasks. It can also be seen that an accuracy of a learned model subjected to domain adaptation via adversarial learning can be equal to or exceed that of normal supervised learning.

Also, when “DARNN” and “Proposed” are compared with each other, it can be seen that “Proposed” provides an accuracy that is higher than or equal to that of “DARNN”. It is indicated that a difference between the two domains lies in the FEL part of the learned model and the process of occurrence of a near miss perceived in the TL are common to the domains.

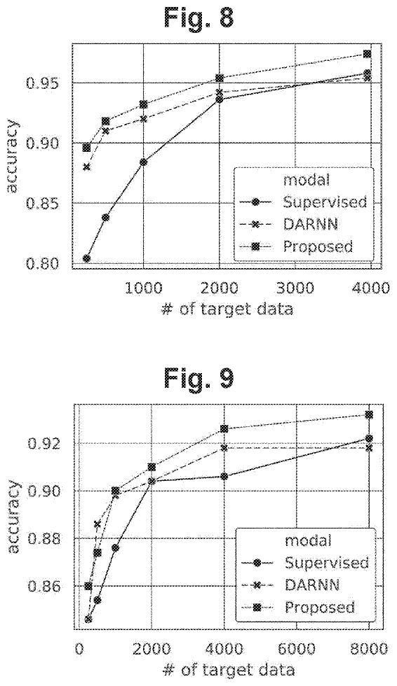

Also, results of tests being conducted with the number of data in the target domain changed without change in ratio between the classes, with the number of target data for training on the x-axis are indicated in FIGS. 8 to 11.

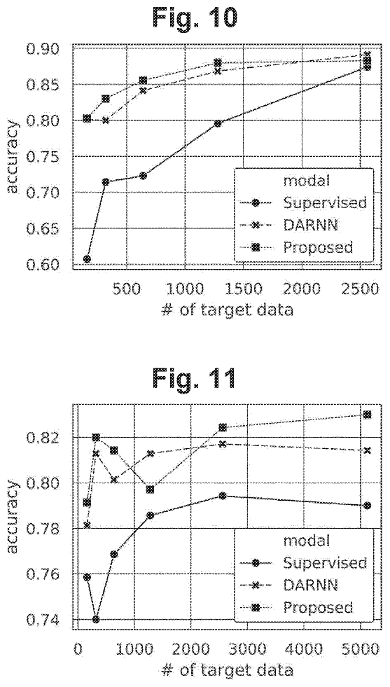

FIG. 8 indicates a result of a 3-class classification task where “data A→data B”. FIG. 9 indicates a result of a 3-class classification task where “data B→data A”. FIG. 10 indicates a result of a 4-class classification task where “data A→data B”. FIG. 11 indicates a result of a 3-class classification task where “data B→data A”.

From these results, it can be recognized that the number of data in the target domain is larger, the accuracy is enhanced more; however, in particular, it can be read that where the number of data in the target domain is small, “DARNN” and “Proposed” are effective.

[1.4 Conclusion]

Example 1 addresses near miss detection and classification under a data collection condition in which no teaching data were provided. In order to solve the tasks, with attention paid to domain adaptation based on adversarial learning, the domain adaptation was applied to only a part of a deep learning network structure, the part being largely different between domains. Also, in a test using actual dashboard camera data, it has been indicated that accuracy that is equal to or exceeds that of supervised learning in a same domain can be achieved using the domain adaptation.

### Example 2

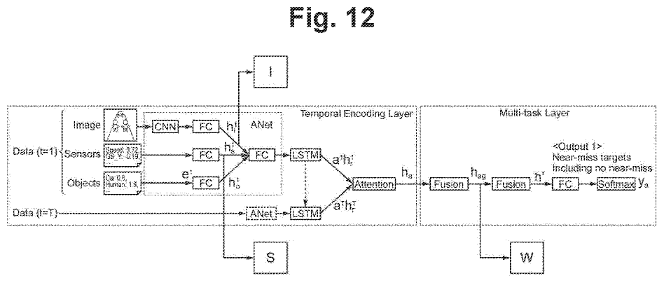

Next, Example 2 will be described. A learning model of Example 2 is a learning model such as illustrated in FIG. 12.

As illustrated in FIG. 12, the learning model of Example 2 is a model including neither a multi-task layer nor a grid G.

As illustrated in FIG. 12, “I” in the figure represents a case where adversarial learning is performed for a modal of an image in data input to the learning model to generate a learned model (Image).

Also, “W” in the figure represents a case where adversarial learning is performed for the entirety of the learning model to generate a learned model (Whole).

Also, “S” in the figure represents a case where adversarial learning performed for a modal of sensor information in data input to the learning model to generate a learned model (Sensor).

In this case, for example, it is conceivable that the learned model is generated by the following combinations. In this case, it is expected that the learned models generated using I or I+S are higher in class classification result accuracy than the learned models generated using N or W.

N: No adversarial learning is performed for learning mode to generate a learned model (None).

W: Adversarial learning is performed for an entirety of a learning model to generate a learned model (Whole).
I: Adversarial learning is performed for a modal of an image in data input to a learning model to generate a learned model (Image).
I+S: Adversarial learning is performed for a modal of a forward image and a modal of sensor information in data input to a learning model to generate a learned model (Image+Sensor).

Note that the learning processing and the classification processing executed by a CPU reading software (program) in the embodiments may be executed by any of various processors other than a CPU. Examples of the processors in this case include, e.g., a PLD (programmable logic device), a circuit configuration of which can be changed after manufacture, such as an FPGA (field-programmable gate array), and dedicated electric circuits that are processors having a circuit configuration designed only for executing specific processing, such as an ASIC (application-specific integrated circuit). Also, the learning processing and the classification processing may be executed by one of such various processors or a combination of two or more processors of a same type or different types (for example, a plurality of FPGAs or a combination of a CPU and an FPGA). Also, a hardware structure of each of such various processors is specifically an electric circuit that is a combination of circuit elements such as semiconductor elements.

Also, although each of the above embodiments has been described in terms of a mode in which a learning program is stored (installed) in advance in the storage 14 and a classification program is stored (installed) in the storage 24, the disclosed technique is not limited to this mode. The programs may be provided in a form in which the programs are stored in a non-transitory storage medium such as a CD-ROM (compact disk read-only memory), a DVD-ROM (digital versatile disk read-only memory) or a USB (universal serial bus) memory. Alternatively, the programs may be downloaded from an external device via a network.

Also, the learning processing and the classification processing in each of the present embodiments may be configured by, e.g., a computer or a server including, e.g., a general-purpose arithmetic processing device and a storage device, and the learning processing and the classification processing may be executed by programs. These programs are stored in the storage device and can be recorded in a recording medium such as a magnetic disk, an optical disk or a semiconductor memory or may be provided through a network.

It should be understood that other components do not necessarily need to be provided by a single computer or a server but may be dispersedly provided by a plurality of computers connected via a network.

The present embodiment is not limited to the above-described embodiments and various alterations and applications are possible without departing from the spirit of the embodiments.

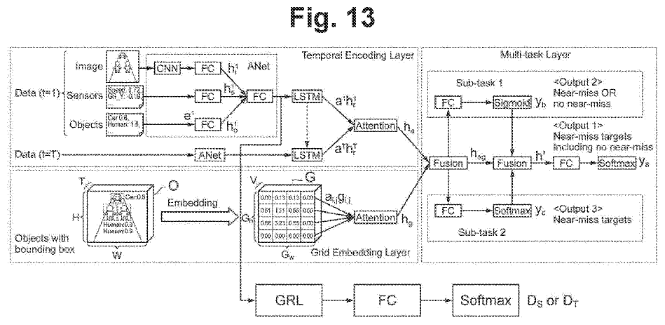

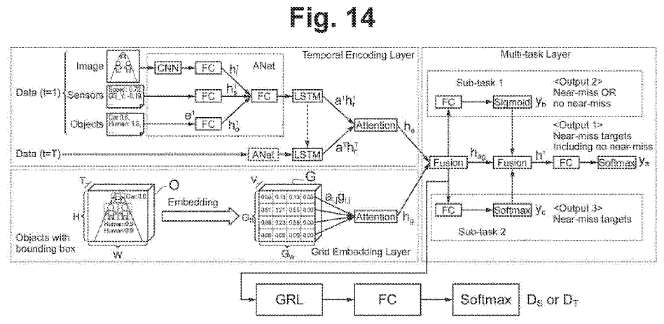

For example, the second embodiment has been described taking a case where the learning model illustrated in FIG. 7 is used; however, the disclosed technique is not limited to this case and the learning model such as in FIG. 13 or FIG. 14 may be used.

In a learning model such as illustrated in FIG. 13, adversarial learning is performed not on a modal-by-modal basis but based on information output from an ANet.

Also, in a learning model such as illustrated in FIG. 14, adversarial learning is performed based on information output from a fusion of a multi-task layer. In this case, a temporal encoding layer is an example of a feature value extraction model.

Also, each of the above embodiments has been described in terms of a case where there are two domains, a source domain and a target domain; however, the disclosed technique is not limited to this case. For example, there may be at least either a plurality of source domains or a plurality of target domains.

For the above embodiments, the below supplement will further be disclosed.

(Supplement Item 1)

A classification device comprising:

a memory; and

at least one processor connected to the memory,

wherein

the processor

acquires input data, and

inputs the acquired input data to a learned model for classifying data into a class, to classify a class of the input data, and

the learned model is a learned model including

a feature value extraction model for extracting a feature value from data, and

a classification model for classifying a class of data based on the feature value extracted by the feature value extraction model,

based on a supervised data set that is a data set in which data belonging to a first domain is provided with a ground truth label representing a class of the data, respective parameters of the feature value extraction model and the classification model being trained in advance in such a manner that a class classification result output from the learned model and the ground truth label correspond to each other,

based on the supervised data set and an unsupervised data set that is a data set in which data belonging to a second domain is provided with no ground truth label representing a class of the data, the parameter of the feature value extraction model being trained in advance via adversarial learning in such a manner that no classification of data input for training as to whether the data is either data in the first domain or data in the second domain is performed.

(Supplement Item 2)

A learning device comprising;

a memory; and

at least one processor connected to the memory,

wherein the processor obtains a learned model for classifying data into a class, by

based on a supervised data set that is a data set in which data belonging to a first domain is provided with a ground truth label representing a class of the data, training a parameter of a feature value extraction model for extracting a feature value from data and a parameter of a classification model for classifying a class of data based on the feature value extracted by the feature value extraction model, in a learning model for classifying data into a class, in such a manner that a class classification result output from the learning model and the ground truth label correspond to each other, and

based on the supervised data set and an unsupervised data set that is a data set in which data belonging to a second domain is provided with no ground truth label representing a class of the data, training the parameter of the feature value extraction model in the learning model via adversarial learning in such a manner that no classification of data input for training as to whether the data is either data in the first domain or data in the second domain is performed.

(Supplement Item 3)

A non-transitory storage medium storing a classification program for making a computer execute processing for:
acquiring input data; and

inputting the input data to a learned model for classifying data into a class, to classify a class of the input data,

the learned model being a learned model including

a feature value extraction model for extracting a feature value from data, and

a classification model for classifying a class of data based on the feature value extracted by the feature value extraction model,

based on a supervised data set that is a data set in which data belonging to a first domain is provided with a ground truth label representing a class of the data, respective parameters of the feature value extraction model and the classification model being trained in advance in such a manner that a class classification result output from the learned model and the ground truth label correspond to each other,

based on the supervised data set and an unsupervised data set that is a data set in which data belonging to a second domain is provided with no ground truth label representing a class of the data, the parameter of the feature value extraction model being trained in advance via adversarial learning in such a manner that no classification of data input for training as to whether the data is either data in the first domain or data in the second domain is performed.

(Supplement Item 4)

A non-transitory storage medium storing a learning program for making a computer execute processing for obtaining a learned model for classifying data into class, by

based on a supervised data set that is a data set in which data belonging to a first domain is provided with a ground truth label representing a class of the data, training a parameter of a feature value extraction model for extracting a feature value from data and a parameter of a classification model for classifying a class of data based on the feature value extracted by the feature value extraction model, in a learning model for classifying data into a class, in such a manner that a class classification result output from the learning model and the ground truth label correspond to each other, and

based on the supervised data set and an unsupervised data set that is a data set in which data belonging to a second domain is provided with no ground truth label representing a class of the data, training the parameter of the feature value extraction model in the learning model via adversarial learning in such a manner that no classification of data input for training as to whether the data is either data in the first domain or data in the second domain is performed.

### REFERENCE SIGNS LIST

10 learning device
20 classification device
101 learning acquisition unit.
102 training data storage unit
103 learned model storage unit
204 learning unit
201 acquisition unit
202 learned model storage unit
203 classification unit

1. A classification device including circuit executing a method, the method comprising:
acquiring input data;
inputting the input data to a learned model for classifying data into a class, to classify a class of the input data,
wherein the learned model includes
a feature value extraction model for extracting a feature value from data, and
a classification model for classifying a class of data based on the feature value extracted by the feature value extraction model,
wherein, based on a supervised data set that is a data set in which data belonging to a first domain is provided with a ground truth label representing a class of the data, respective parameters of the feature value extraction model and the classification model are trained in advance in such a manner that a class classification result output from the learned model and the ground truth label correspond to each other, and
wherein, based on the supervised data set and an unsupervised data set that is a data set in which data belonging to a second domain is provided with no ground truth label representing a class of the data, the parameter of the feature value extraction model is trained in advance via adversarial learning in such a manner that no classification of data input for training as to whether the data is either data in the first domain or data in the second domain is performed.

2. The classification device according to claim 1,
wherein the data includes a plurality of kinds of data, and
wherein the parameter of the feature value extraction model in the learned model is a parameter trained in advance via adversarial learning for each of the kinds of the data.

3. A learning device including circuit executing a method, the method comprising:
obtaining a learned model for classifying data into a class, wherein the obtaining includes:
based on a supervised data set that is a data set in which data belonging to a first domain is provided with a ground truth label representing a class of the data, training a parameter of a feature value extraction model for extracting a feature value from data and a parameter of a classification model for classifying a class of data based on the feature value extracted by the feature value extraction model, in a learning model for classifying data into a class, in such a manner that a class classification result output from the learning model and the ground truth label correspond to each other, and
based on the supervised data set and an unsupervised data set that is a data set in which data belonging to a second domain is provided with no ground truth label representing a class of the data, training the parameter of the feature value extraction model in the learning model via adversarial learning in such a manner that no classification of data input for training as to whether the data is either data in the first domain or data in the second domain is performed.

4. A computer-implemented method for classifying, the method comprising:
acquiring input data; and
inputting the input data to a learned model for classifying data into a class, to classify a class of the input data,
the learned model including:
a feature value extraction model for extracting a feature value from data, and
a classification model for classifying a class of data based on the feature value extracted by the feature value extraction model,
based on a supervised data set that is a data set in which data belonging to a first domain is provided with a ground truth label representing a class of the data, respective parameters of the feature value extraction model and the classification model being trained in advance in such a manner that a class classification result output from the learned model and the ground truth label correspond to each other, and
based on the supervised data set and an unsupervised data set that is a data set in which data belonging to a second domain is provided with no ground truth label representing a class of the data, the parameter of the feature value extraction model being trained in advance via adversarial learning in such a manner that no classification of data input for training as to whether the data is either data in the first domain or data in the second domain is performed.

5-7. (canceled)

8. The classification device according to claim 1, wherein the input data include video data collected from one or more dashboard cameras, and wherein the class of data includes a traffic accident or a near miss.

9. The classification device according to claim 1, wherein the learning model includes a neural network.

10. The learning device according to claim 3, wherein the input data include video data collected from one or more dashboard cameras, and wherein the class of data includes a traffic accident or a near miss.

11. The learning device according to claim 3, wherein the learning model includes a neural network.

12. The computer-implemented method according to claim 4, wherein the input data include video data collected from one or more dashboard cameras, and wherein the class of data includes a traffic accident or a near miss.

13. The computer-implemented method according to claim 4, wherein the learning model includes a neural network.

14. The computer-implemented method according to claim 4,
wherein the data includes a plurality of kinds of data, and
wherein the parameter of the feature value extraction model in the learned model is a parameter trained in advance via adversarial learning for each of the kinds of the data.
